(19) United States
(12) Patent Application Publication
(10) Pub. No.: US 2010/0073318 A1
(43) Pub. Date: Mar. 25, 2010

(54) MULTI-TOUCH SURFACE PROVIDING DETECTION AND TRACKING OF MULTIPLE TOUCH POINTS

(75) Inventors: Nan Hu, Stanford, CA (US); David Kryze, Santa Barbara, CA (US); Luca Rigazio, Santa Barbara, CA (US); Rabindra Pathak, San Jose, CA (US)

Correspondence Address: GREGORY A. STOBBS, 5445 CORPORATE DRIVE, SUITE 400, TROY, MI, 48098, US

(73) Assignee: MATSUSHITA ELECTRIC INDUSTRIAL CO., LTD., Osaka (JP)

(21) Appl. No.: 12/237,143

(22) Filed: Sep. 24, 2008

(51) Int. Cl. G06F 3/045

(52) U.S. Cl. 345/174

(57) ABSTRACT

System and method for touch sensitive surface provide detection and tracking of multiple touch points on the surface by using two independent arrays of orthogonal linear capacitive sensors.

### FIELD

The present disclosure relates to a multi-touch surface providing detection and tracking of multiple touch points.

### BACKGROUND AND SUMMARY

Human machine interactions for consumer electronic devices are gravitating towards more intuitive methods based on touch and gestures and away from the existing mouse and keyboard approach. For many applications touch sensitive surface is used for users to interact with underlying systems. Same touch surface can also be used as display for many applications. Consumer electronics displays are getting thinner and less expensive. Hence there is need for a touch surface that is thin and inexpensive and provides multi-touch experience.

In order to provide multi-touch interaction on a surface, several different sensors, such as IR sensors, camera sensors and pressure sensors, have been sued. These sensors can be expensive, complex and take more space resulting in thicker display and bulkier end products. Capacitive sensors provide a cheaper and thinner alternative. Two-dimensional capacitive sensors have been used for multi-touch application having smaller surface area. Employing capacitive sensors for multi-touch application having large size surface, however, can be difficult due to increased need for information processing. The complexity of two-dimensional capacitive sensors grows exponentially as size of the surface area increases. Along with complexity, costs for producing for the two-dimensional capacitive sensors also increase.

The present disclosure provides two independent arrays of orthogonal linear capacitive sensors. One or more embodiments of the present disclosure can provide a simpler and less expensive alternative to two-dimensional capacitive sensors for multi-touch applications with larger surfaces. One or more embodiments of the present disclosure can be packaged in a very thin foil at lower costs than using other sensors for multi-touch solutions. One or more embodiments of the present disclosure aim to accurately detect and track multiple touch points.

The inventors of the present disclosure propose an apparatus detecting at least one touch point. The apparatus has a surface having a first dimension and second dimension. A first plurality of sensors are deployed along the first dimension and generating a first plurality of sensed signals caused by the at least one touch point. The first plurality of sensors provide a first dataset indicating the first plurality of sensed signals as a first function of position on the first dimension. A second plurality of sensors are deployed along the second dimension and generating a second plurality of sensed signals caused by the at least one touch point. The second plurality of sensors provide a second dataset indicating the second plurality of sensed signals as a second function of position on the second dimension. The first plurality of sensors and the second plurality of sensors operate independently to each other. A trained-model based processing unit processes the first and second datasets to determine a position for each of the at least one touch point.

### DRAWINGS

The drawings described herein are for illustrative purposes only of selected embodiments and not all possible implementations, and are not intended to limit the scope of the present disclosure.

FIG. 1A is a drawing illustrating a multi-touch device;

FIG. 1B is a schematic drawing illustrating one embodiment of the present disclosure;

FIG. 2 is a drawing illustrating exemplary capacitance detection readings for a single touch point;

FIG. 3 is a drawing illustrating an exemplary parabola fitting for a single touch point;

FIG. 4 is a drawing illustrating exemplary capacitance detection readings for two touch points;

FIG. 5 is a drawing illustrating an exemplary parabola fitting for two touch points;

FIG. 6 is a schematic drawing illustrating another embodiment of the present disclosure;

FIG. 7A is a drawing illustrating exemplary capacitance detection readings for a single touch point;

FIG. 7B is a drawing illustrating exemplary capacitance detection readings for two touch points;

FIG. 8A is a drawing illustrating exemplary training data for a single touch point;

FIG. 8B is a drawing illustrating exemplary training data for two touch points;

FIG. 9 is a drawing illustrating K-fold cross validation;

FIG. 10 is a schematic drawing illustrating another embodiment of the present disclosure;

FIG. 11 is a drawing illustrating an exemplary operation of a touch point tracker of one embodiment of the present disclosure; and

FIG. 12 is a drawing illustrating a Hidden Markov Model.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

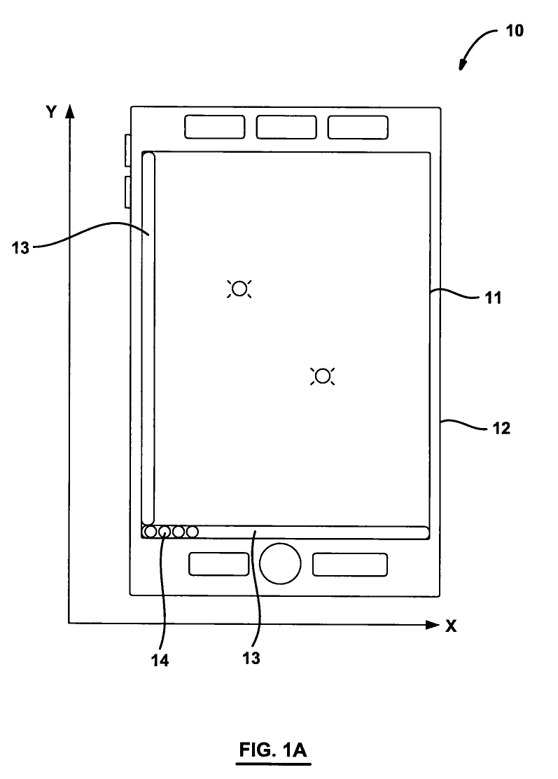

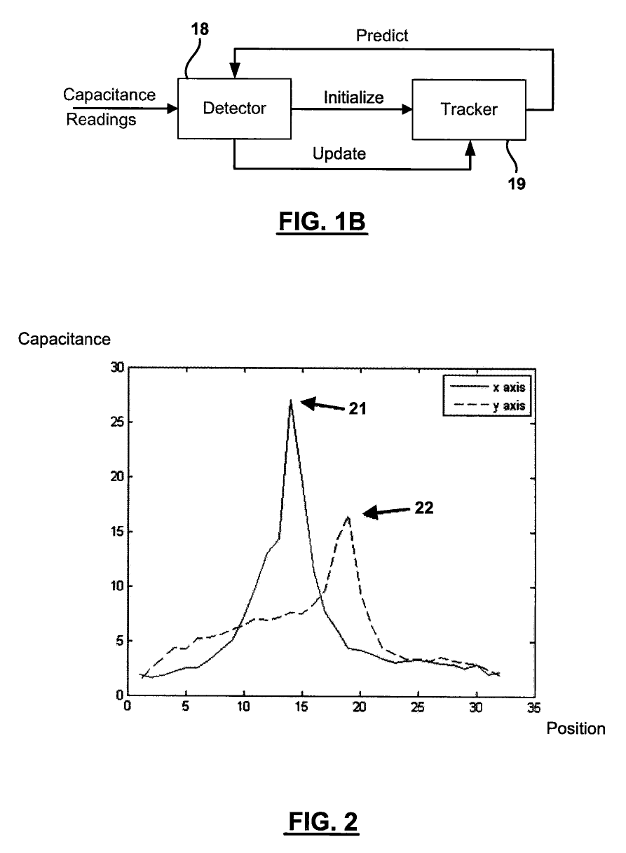

Referring to FIG. 1A, one or more embodiments of the present disclosure are now described. An interactive foil 12 is employed in a multi-touch surface 11 of a multi-touch device. The interactive foil has two arrays of independent capacitive sensors 13. Although capacitive sensors are used in this embodiment, two arrays of independent sensors of other type can be alternatively employed in the interactive foil 12. The two arrays of independent capacitive sensors 13 are deployed on both the vertical and horizontal direction of the interactive foil. The vertical direction is referred to as y-axis and the horizontal direction is referred to as x-axis. Thus, one array of capacitive sensors 13 sense x-coordinate and the other array of capacitive sensors 13 sense y-coordinate of touch points on the surface of the foil 12. One or more capacitive sensors 14 can be deployed at each detection points on x-axis or y-axis. Thus, two arrays of capacitive sensors 13 can provide the location of a touch point such as a touch of a finger on the interactive foil 12. The interactive foil 12 can be mounted under one glass surface or sandwiched between two glass surfaces. Alternatively it can be mounted on a display surfaces like TV screen panels.

The capacitive sensor 14 is sensitive to conductive objects like human body parts when the objects are near the surface of the interactive foil 12. The capacitive sensors 13 read sensed capacitance values on the x-axis and y-axis independently. When an object, e.g. a finger, comes close enough to the surface, the capacitance values on the corresponding x-axis and y-axis increase. The values at the x-axis and y-axis thus make possible the detection of a single or multiple touch points on the interactive foil 12. Giving a specific example, the foil 12 can be 32 inches long diagonally, and the ratio of the long and short sides can be 16:9. Therefore, the corresponding sensor distance in the x-axisaxis is about 22.69 mm and that in the y-axis is about 13.16 mm.

Referring now to FIG. 1B, a general structure of a trained-model based processing unit in one or more embodiment of the present disclosure is now described. A detector 18 continuously reads the capacitance values of the two independent arrays of capacitive sensors 13. The detector 18 initializes a tracker 19 to predict tracks of one or more touch points. The tracker 19 provides feedbacks to the detector 18. The detector 18 can also update the tracker 19 regarding its predictions. Other modules and algorithms are also implemented to detect the multi-touch points based on the capacitance detection readings from the two independent arrays of capacitive sensors 13. These will be described in detail later.

Before discussing detecting multiple touch points from the detection readings of the two independent arrays of capacitive sensors 13, it is helpful to briefly discuss detection of a single touch point on the interactive foil 12. Referring now to FIG. 2, sample capacitance detection readings of a single touch point from the interactive foil 12 are shown. For a single touch point, all the capacitive sensors 13 on x-axis and y-axis generate capacitance detection readings. On each of the x-axis and y-axis, one peak exists. To detect the peaks, the detector 18 receives capacitance detection readings from the capacitive sensors 13 and searches for the maximum capacitance values on both x-axis and y-axis. The result x and y values corresponding to the peaks (21, 22) on x-axis and y-axis respectively can indicate the position of the touch point. This detection gives at least a pixel level accuracy.

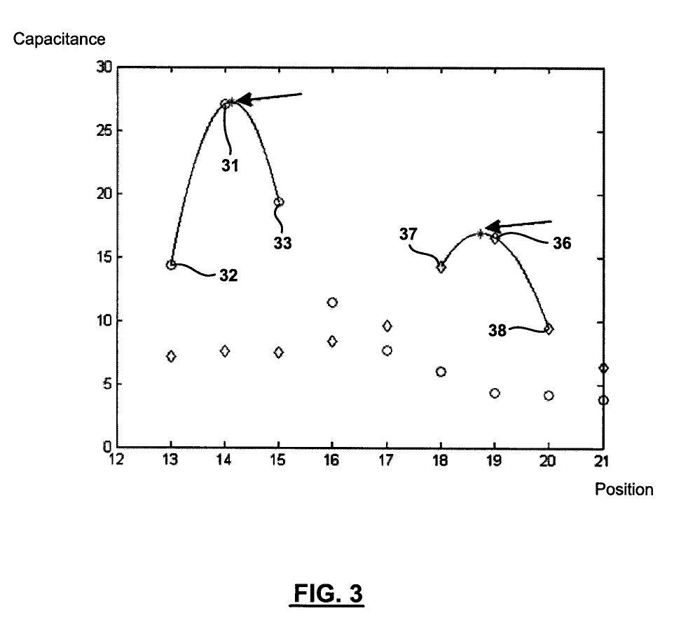

Referring now to FIG. 3, a local parabola fitting technique can be employed to improve the accuracy of the detected peak values (31, 36). This technique can include detection points on both the left (32, 37) and the right (33, 38) of the detected peak points (31, 36). The local parabola fitting technique will be described in detail later. Generally speaking, the position at the maximum of the parabola is then found and considered as the peak position at the sub-pixel level.

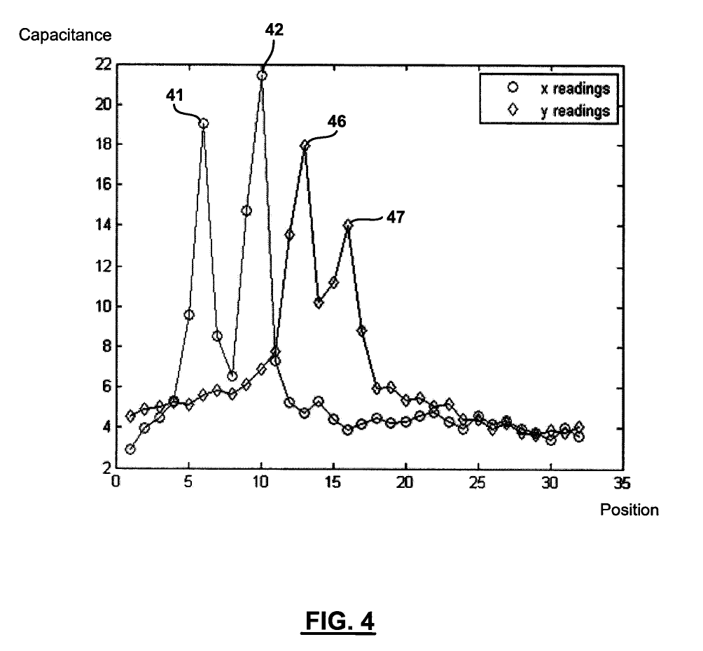

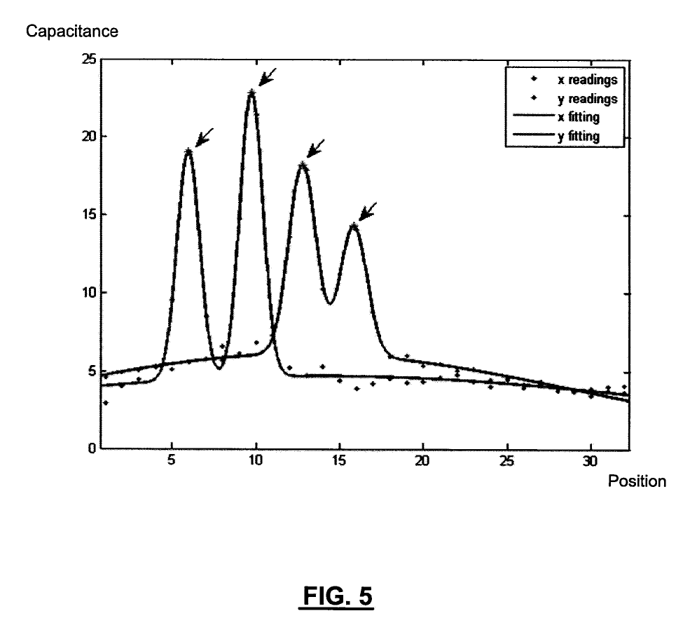

Referring now to FIG. 4, detection of multiple touch points in one or more embodiments of the present disclosure is now described. To simplify the discussion, a scenario where two touch points are detected and tracked is considered. The technique described here, however, can be applied to scenarios where more than two touch points are detected and tacked. Generally speaking, two touch points on the surface of the interactive foil will result in two local maxima (41, 42; 46, 47) in the capacitance detection reading on each axis. With the effect of noise, however, more than two local maxima may be detected. Also, in some circumstances when two fingers are very close, the two fingers may simulate a single touch point and there may be only one local maximum in the capacitance detection readings. To differentiate these situations, more advanced curve fitting algorithms can be used. For example, such a fitting can be based on a mixture of Gaussian functions. The technique based on Gaussian functions will also be discussed later. One sample capacitance detection readings from the capacitive sensors 13 for two touch points on the interactive foil 12 are shown in FIG. 4. A corresponding fitting and the sub-pixel touch positions are shown in FIG. 5.

Considering a situation for detecting two touch points, because the background noise may also be modeled as a Gaussian, a sum of three Gaussian functions will be fitted. Two of the three component Gaussians can be identified as correlating to the tow touch points to be detected. The third one having a very small peak value comparing to the other two can be rejected as noise.

A discussion regarding detecting and searching one or more peak points from the capacitance detection readings of the capacitive sensors 12 has been presented. However, before one or more embodiments of the present disclosure can utilize the above techniques to search for peak points from the capacitance detection readings, the number of touch points for which the capacitance detection readings are generated needs to be known. The reason is simple: if only one touch point is on the interactive foil, only one peak point needs to be searched; if two or more touch points are on the interactive foil, two or more peak points need to be searched.

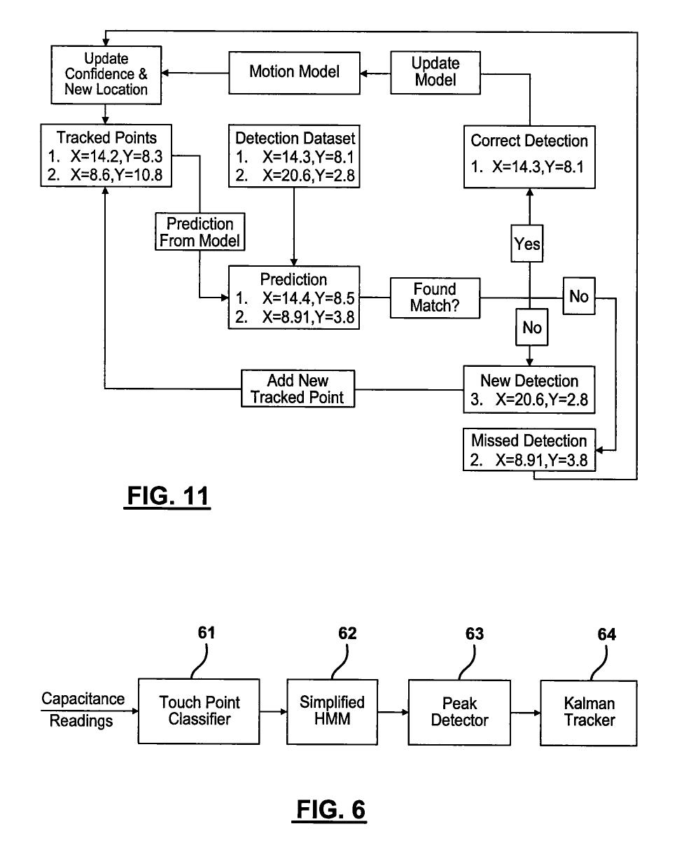

Referring now to FIG. 6, one or more embodiments of the present disclosure can employ a touch point classifier 61 that analyzes the capacitance detection readings from the capacitive sensors 13 and determine the number of touch points that are on the interactive foil 12. From now a scenario that has only one or two touch points on the interactive foil is considered. The techniques described here, however, can be applied to scenarios have more than two touch points on the interactive foil.

The capacitance detection readings from the capacitive sensors 13 are first passed to the touch point classifier 61, which was trained off-line to classify between single touch point and two touch points. The classification results are then fed into a Hidden Markov Model 62 to update the posterior probability. Once the posterior probability reaches a predetermined threshold, the corresponding number of the touch points is confirmed and a peak detector 63 searches the readings to find the local maxima. A Kalman tracker 64 is then used to track the movement of the touch points.

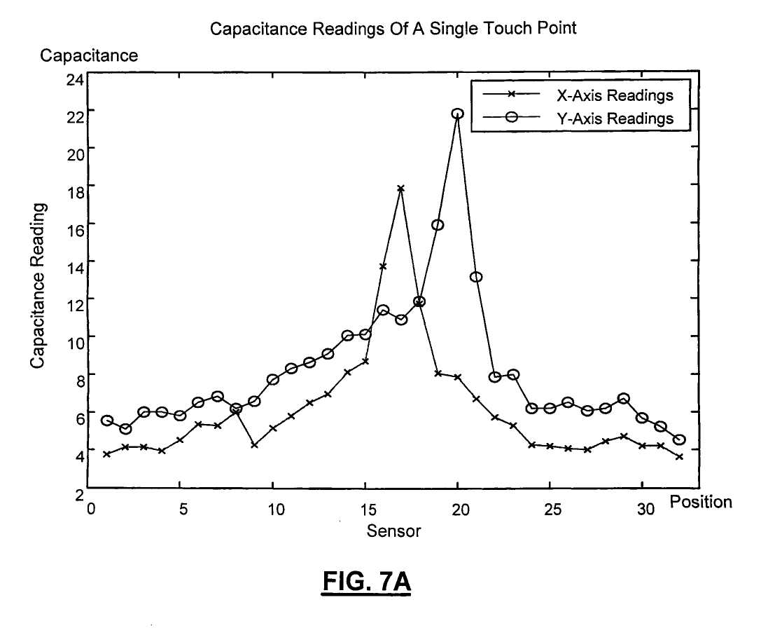

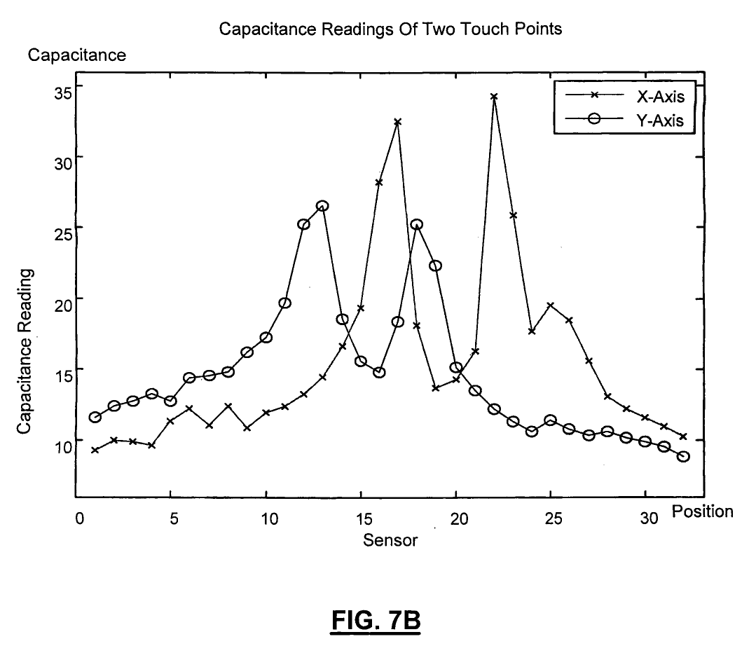

Referring now to FIG. 7A, sample detection readings of a single touch point is illustrated. The x-axis of the coordinate system in this diagram corresponds to positions in the x-axis or y-axis of the interactive foil 12. The y-axis of the coordinate system corresponds to the values of detections from the capacitive sensors at a give position on x-axis or y-axis of the interactive foil 12. FIG. 7B similarly illustrates sample capacitance detection readings of two touch points.

One goal of one or more embodiments of the present disclosure is to analyze the capacitance detection readings and determine if the reading is from a single touch point or two touch points. The inventors of the present disclosure propose using a computational mechanism to analyze the capacitance detection readings and for example statistically determine if the capacitance detection readings are from a single touch point or two touch points. The computational mechanism can be a trained-model based mechanism. The inventors of the present disclosure further propose employing a classifier for this analysis.

A classifier can be defined as a function that maps an unlabeled instance to a label identifying a class according to an internal data structure. For example, the classifier can be used to label the capacitance detection readings as single touch point or two touch points. The classifier extract significant features from the information received (the capacitance detection readings in this example) and labels the information received based on those features. These features can be chosen in such way that clear classes of the information received can be identified.

A classifier needs to be trained by using training data in order to accurately label later received information. During training, underlying probabilistic density functions of the sample data are being estimated.

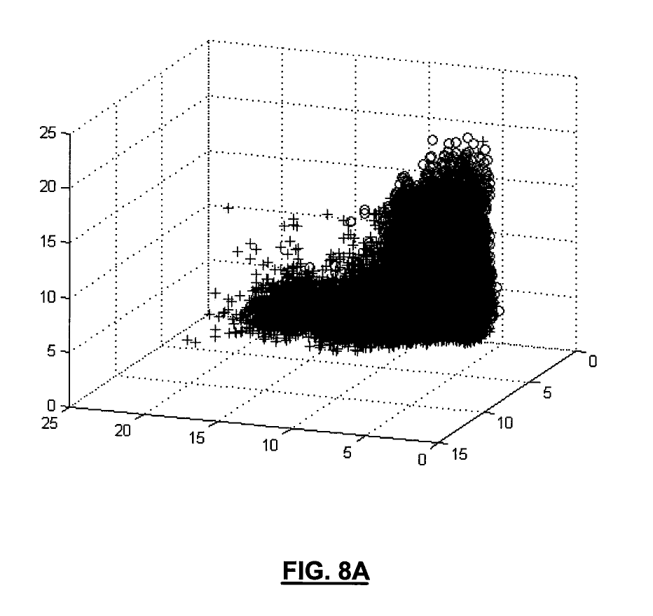

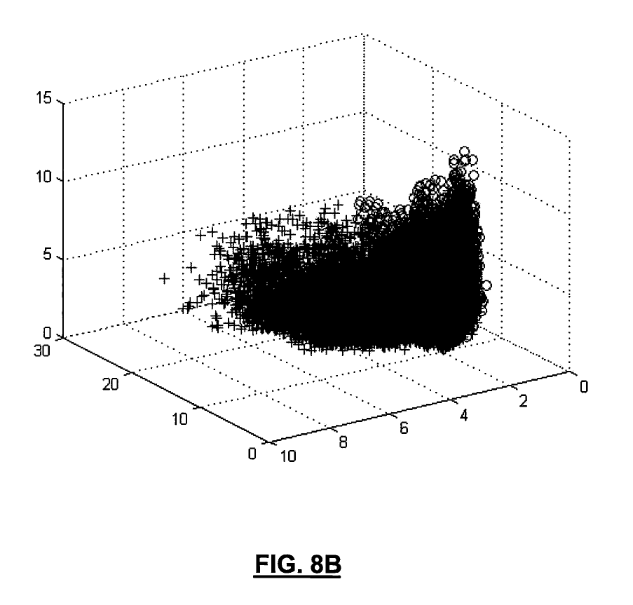

Referring now to FIG. 8A, sample training data for a single touch point in a three-dimensional coordinate system are shown. The sample training data can be generated for example by using two-dimensional capacitive sensors that are deployed on a training foil. The x-y plane of the three-dimensional coordinate system corresponds to the x-y plane of the training foil. Z-axis of the three-dimensional coordinate system corresponds to the capacitance detection reading of the two-dimensional capacitive sensors at a give point at the x-y plane of the training foil. FIG. 8B similarly illustrates sample training data of two touch points. The visualized sample data can be referred to as point clouds.

The inventors of the present disclosure further propose using a Gaussian density classifier. During training, for example, point clouds received from the two-dimensional capacitive sensors is to be labeled by the Gaussian density classifier as one of two classes: one-touch-point class and two-touch-point class. In a Gaussian density classifier, a probabilistic density function of received data (e.g., point clouds) with respect to the different classes is modeled as a linear combination of multivariate Gaussian probabilistic density functions.

Suppose samples of each group are from a multivariate Gaussian density N(μₖ, Σₖ), k=1, 2. Let xᵢ^{k} ε R^{d} be the i-th sample point for the k-th group, i=1, . . . , Nₖ. For each group, the Maximum Likelihood (ML) estimation of the mean μₖ and covariance matrix σₖ is

$${μ}_{k} = \frac{1}{{N}_{k}} {\sum }_{i} {x}_{i}^{k} , {\sum }_{k} = \frac{1}{{N}_{k}} {\sum }_{k} ( {x}_{i}^{k} - {μ}_{k} ) {( {x}_{i}^{k} - {μ}_{k} )}^{T} .$$

With this estimation, the boundary is then defined as the equal Probabilistic Density Function (PDF) curve, and is given by x^{T}Qx+Lx+K=0, where Q=Σ₁⁻¹−Σ₂⁻¹, L=−2(μ₁Σ₁⁻¹−μ₂Σ₂⁻¹), K=μ₁^{T}Σ₁⁻¹μ₁−μ₂^{T}Σ₂⁻¹μ₂−log|Σ₁|+log|Σ₂|.

The present disclosure now describes determining features from the capacitance detection readings need to be extracted for the Gaussian density classifier in one or more embodiments of the present disclosure. The inventors of the present disclosure propose to use statistics of the capacitance detection readings, such as mean, the standard deviation and the normalized higher order central moments, as features to be extracted. Note that the statistics of the reading may be stable even though the position of the peak and the value of the each individual sensor may vary. Features are then selected as the statistics of the capacitance detection readings on each axis. The inventors of the present disclosure then propose to determine a suitable set of and/or number of features by using K-fold cross validation on a training dataset with features up to the 8th normalized central moment.

Generally speaking, in a K-fold cross validation, a training dataset is randomly split into K mutually exclusive subsets of approximately equal size. Of the K subsets, a single subset is retained as the validation data for testing the model, and the remaining K−1 subsets are used as training data. The cross-validation process is then repeated K times (the folds), with each of the K subsets used exactly once as the validation data. The K results from the folds then can be averaged (or otherwise combined) to produce a single estimation.

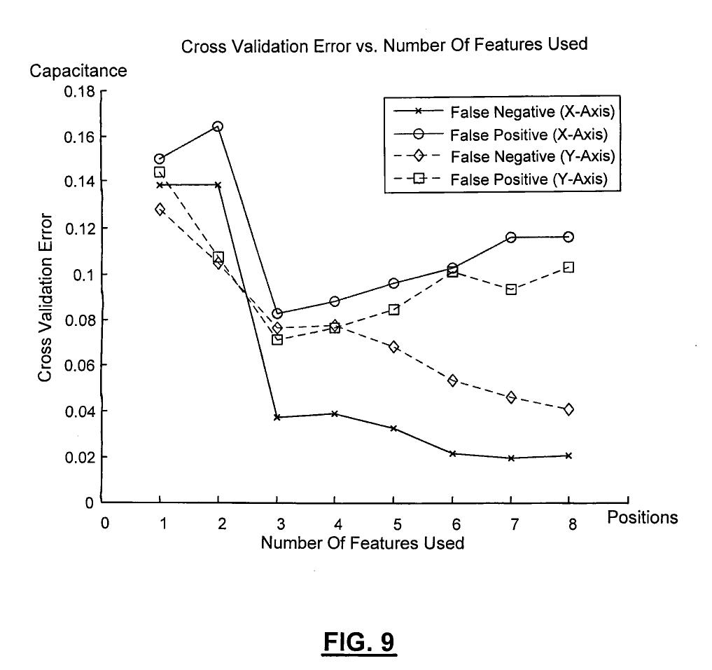

In one or more embodiments of the present disclosure, K-fold cross validation is employed to train and validate the Gaussian density classifier. The estimated false positive and false negative rates are shown in FIG. 9. Based on this validation, the inventors of the present disclosure decide the number of features preferably can be three and the features are the mean, the standard deviation, and the skewness of the capacitance detection readings.

Thus, one or more embodiments of the present disclosure can extract mean, standard deviation and skewness of capacitance detection readings received from the capacitive sensors at a given time t. The Gaussian density classifier then determines whether the capacitance detection readings received is from a single touch point or from two touch points based on the extracted features.

Further, the inventors of the present disclosure recognize that results from the Gaussian density classifier (i.e., a single touch point or two touch points) can be connected over time to smooth the detection over time in a probabilistic sense and to confirm the results determined by the Gaussian density classifier. In one or more embodiments of the present disclosure, a confirmation module receives current result signals from the touch point classifier 61 and determines a probability of occurrence of the current result (i.e., either a single touch point or two touch points) based on result signals previously received. If the probability reaches a predetermined threshold, then the current result from the touch point classifier 61 is confirmed. The inventors of the present disclosure further propose to employ a Hidden Markov Model in the confirmation module.

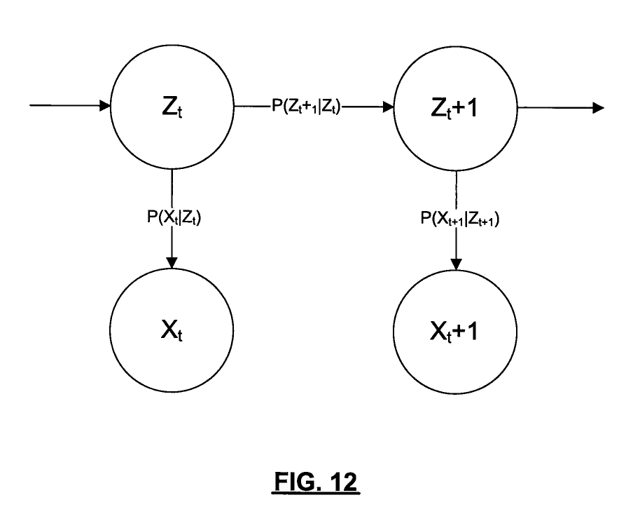

Referring now to FIG. 12, a Hidden Markov Model (HMM) employed in one or more embodiments of the present disclosure is now described. The HMM can be used to evaluate the probability of occurrence of a sequence of observations. For example, the observations can be the determined result from the touch point classifier 61: a single touch point or two touch points. The observation at time t is represented as Xₜ ε{O₁, O₂}, wherein O₁ and O₂ represent two observations: a single touch point and two touch points respectively.

The sequence of observations may be modeled as a probabilistic function of an underlying Markov chain having state transitions that are not directly observable. For example, the HMM can have two hidden states. At the given time t, the hidden states can be represented as Z₁ ε{S₁, S₂}, wherein S₁ and S₂ represent two states: a single-touch-point state and a two-touch-point state respectively. Because only a scenario having one or two touch points is considered now, two hidden states are adapted for the HMM. In a scenario where more than two touch points need to be detected, more than two hidden states can be adapted for the HMM.

The probability of transition from state Zₜ at time t to state Zₜ₊₁ at time (t+1) is represented as: P(Zₜ₊₁|Zₜ).

At time t, the probability of observing Xₜ if the HMM is at state Zₜ is represented at P(Xₜ|Zₜ).

The inventors of the disclosure discover that a homogeneous HMM can be applied to one or more embodiments of the disclosure. In a homogeneous HMM, the possibilities of transition at two consecutive time points are the same: P(Zₜ_{₁}₊₁|Zₜ_{₁})=P(Zₜ_{₂}₊₁|Zₜ_{₂}), ∀t₁t₂. In addition the probabilities of observing the outcomes at two close time points are the same:

P(X_{t+δ}|Zₜ₊₆₇ )=P(Xₜ|Zₜ), ∀δε Z⁺.

At time 0 the possibility of transition is assumed to be P(Z₀)=0.5 based on Bernoulli distribution. At a given time t, suppose the probability of state P(Zₜ₋₁) at time (t−1) is known and observation Xₜ is received from the touch point classifier 61, the hidden state is then updated by the Bayesian rule as

$$P ( {Z}_{t} \vert {X}_{t} , {Z}_{t - 1} ) = \frac{P ( {X}_{t} \vert {Z}_{t} ) P ( {Z}_{t} \vert {Z}_{t - 1} ) P ( {Z}_{t - 1} )}{P ( {Z}_{t - 1} ) {\sum }_{{Z}_{t}} P ( {X}_{t} \vert {Z}_{t} ) P ( {Z}_{t} \vert {Z}_{t - 1} )} .$$

The inventors of the disclosure discover that decisions can be made based on the posterior probability P(Zₜ|Xₜ, Zₜ₋₁) instead of based on maximizing the joint likelihood to find the best sequence of the state transitions. A threshold can be predefined to verify the observations from the touch point classifier. If the calculated posterior probability P(Zₜ|Xₜ, Zₜ₋₁) is higher than the predefined threshold, the state at time t is confirmed by the posterior probability P(Zₜ|Xₜ, Zₜ₋₁). A high threshold can be set to obtain higher accuracy.

The result from the touch point classifier 61 is now confirmed by the confirmation module. In other words, the capacitance detection readings from the capacitive sensors are analyzed by the touch point classifier and confirmed to be either from a single touch point or two touch points in this example.

Referring now again back to FIG. 6, now the confirmed number of touch points Nₜ is passed to the peak detector 63. The peak detector 63 also receives the capacitance detection readings and then search for the first Nₜ largest local maxima. For example, if the result from the touch point classifier 61 and confirmation module is one touch point, the peak detector 63 searches for global maximum values from capacitance detection readings on both x-axis and y-axis of the interactive foil 12. If the result from the touch point classifier 61 and confirmation module are two touch points, the peak detector 63 searches for two local maxima from capacitance detection readings on both x-axis and y-axis of the interactive foil 12. The peak detector 63 can also employ a ratio test for the two peak values found on each of the x-axis and y-axis. When the ratio of the values of the two peaks of capacitance detection readings on an axis exceeds a predetermined threshold, the lower peak is deemed as a noise, and the two touch points are determined to coincide with each other on that axis of the interactive foil 12.

To achieve a subpixel accuracy, the inventors of the present disclosure propose to employ a parabola fitting process for each local maximum pair (xₘ,f(xₘ)) on each axis (i.e.: x-axis and y-axis) of the interactive foil, where xₘ is the position and f(xₘ) is the capacitance detection reading value. The local maximum pair (xₘ,f(xₘ)) together with one point on each side of the peak position, (xₘ₋₁,f(xₘ₋₁)) and (xₘ₊₁,f(xₘ₊₁)), are fit into a parabola f(x)=ax²+bx+c. This is equivalent to solving a linear system

$$( \begin{matrix}{x}_{m + 1}^{2} & {x}_{m + 1} & 1 \\ {x}_{m}^{2} & {x}_{m} & 1 \\ {x}_{m - 1}^{2} & {x}_{m - 1} & 1\end{matrix} ) ( \begin{matrix}a \\ b \\ c\end{matrix} ) = ( \begin{matrix}f ( {x}_{m + 1} ) \\ f ( {x}_{m} ) \\ f ( {x}_{m - 1} )\end{matrix} ) .$$

Thus, the peak position is refined to

$${x}_{m} = - \frac{b}{2 a} .$$

In one or more embodiments of the disclosure, by using the above described techniques, the peak detector 63 can determine one or two peak positions for each of x-axis and y-axis of the touch screen. In some other embodiments, more than two peak points on each axis can be similarly determined.

Because the two arrays of capacitive sensors 13 on the interactive foil 12 are independent, positions on x-axis and y-axis need to be associated together to determine the touch points in the two-dimensional plane of the interactive foil. When there are two peaks on both x-axis (x₁,x₂) and y-axis (y₁,y₂), there are two pair of possible associations (x₁,y₁), (x₂,y₂) and (x₁,y₂), (x₂,y₁), which have equal probability. The inventors of the present disclosure recognize that the two possible associations can pose ambiguity at the very beginning of detection when no other data has been collected to assist determination of the association. Thus, the inventors of the present disclosure propose to restrict the detection to start from a single touch point.

In one or more embodiments of the present disclosure, the history of detected touch points is stored in a data store of the embodiment. The data store for example can be deployed within the processing unit. A table in the data store records the x and y values for each touch point at each time point. This history data is then utilized by the tracker 19 to determine movements of the touch points. The tracker 19 based on the history data can predict and assign one or more trajectories to a touch point. Based on the determined trajectories, the tracker 19 can determine an association of current peaks on the x-axis and y-axis detected by the peak detector 63. In this way, the processing unit can more accurately determine the current position for each touch point.

The inventors of the present disclosure further propose a technique to enhance the detection results as well as to smooth the trajectory as the touch point moves. No matter what detection methods are used, it will inevitably include missed detections, both in term of false positive and false negative. Missed detections can happen either due to system or environment noise or the way a person touches the surface. For example, if a person intended to touch the surface with index finger, but the middle finger or the thumb is very close to the surface, then those fingers can be falsely detected. To enhance the detection results as well as to smooth the trajectory as the touch point moves, a tracking method is employed.

In one or more embodiments of the disclosure, the inventors of the present disclosure propose to employ a Kalman filter as the underlying model for a touch point tracker. Kalman filter provides a prediction based on previous observations and after the detection is confirmed it can also update the underlying model. Kalman filter records the speed at which the touch point moves and the prediction is made based on the previous position and the previous speed of the touch point.

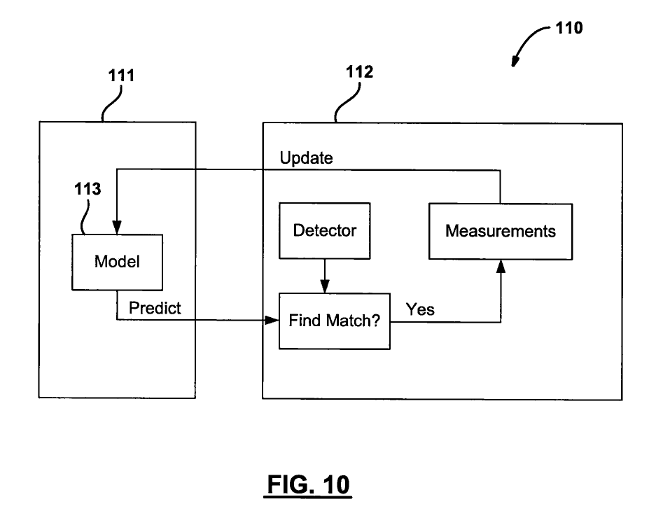

Referring now to FIG. 10, a touch point tracker with a Kalman Filter in one or more embodiments of the present disclosure is shown.

The touch point tracker 110 can use the Kalman filter 111 as the underlying motion model to output a prediction based on previously detected touch points. Based on the prediction, a match finder 112 is deployed to search a best match in a detection dataset. Once a match is found, a new measurement is taken and the underlying model 113 is updated according the measurements.

Referring now to FIG. 11, an example of operation of the touch point tracker 110 is shown. A tracked point set has two points (points 1 and 2). Point 1 and point 2 in this example are at locations (X=14.2, Y=8.3) and (X=8.6, Y=10.8) of the interactive foil at start. The touch point tracker then makes a prediction for each of the two points. In this example, the touch point tracker predicts points 1 and 2 will move to location (X=14.4, Y=8.5) and location (X=8.91, Y=3.8) respectively. Then for each prediction, a search algorithm is used to find matches in the detection dataset. In this example, the detection dataset includes two points (X=14.3, Y=8.1) and (X=20.6, Y-2.8). A match for point 1 is found, i.e. at point (X=14.3, Y=8.1), but not for point 2. Once a match is found, the position of the matched point is recorded as a measurement for that touch point and the underlying motion model for that touch point is updated accordingly. The confidence level about that touch point is then updated. If the match point is not found then the motion model is not updated and the confidence level for the touch point is not updated. Once a new touch point is detected, i.e., a detected point which has no match in the tracked point set a new record for that touch point is added and the corresponding confidence level is initialized. In this example, a new record for point (X=20.6, Y=2.8) is added. When a determined confidence about a touch point is not satisfactory (e.g., does not meet a predetermined threshold), the record of that touch point can be deleted.

In one or more embodiments of the present disclosure, to associate touch points at different time frames as well as smooth the movement, a Kalman filter with a constant speed model is employed. A state vector is defined as z=(x,y,Δx,Δy), where (x,y) are the position on the touch screen, (Δx,Δy) are the change in position between adjacent time frames, and x̅=(x′,y′) is the measurement vector which is the estimation of the position from the peak detector.

The transition of the Kalman filter satisfies

$${\overline{z}}_{t + 1} = H {\overline{z}}_{t} + w$$

$${\overline{x}}_{t + 1} = M {\overline{z}}_{t + 1} + u$$

where in our problem,

$$H = ( \begin{matrix}1 & 0 & 1 & 0 \\ 0 & 1 & 0 & 1 \\ 1 & 0 & 0 & 0 \\ 0 & 1 & 0 & 0\end{matrix} ) , and M = ( \begin{matrix}1 & 0 & 0 & 0 \\ 0 & 1 & 0 & 0\end{matrix} )$$

are the transition and measurement matrix, w˜N(0,R) and v˜N(0,Q) are white Gaussian noises with covariance matrices R and Q.

Given prior information from past observations zₜ˜N(μₜ,Σ), the update once the measure is available is given by

zₜ^{post}=μₜ+ΣM^{T}(MΣM^{T}+R)⁻¹( x̅ₜ−Mμₜ)

Σ^{post}=Σ−M^{T}(MΣM^{T}+R)⁻¹M

μₜ₊₁=Hzₜ^{post}

Σ=HΣ^{post}H^{T}+Q

where zₜ^{post} is the correction when the measurement x̅ₜ is given, μₜ is the prediction from previous time frame. When a prediction from previous time frame is made, the nearest touch point in the current time frame is found in term of Euclidean distance, and is taken as the measurement to update the Kalman filter to find the correction as the position of the touch point. If the nearest point is outside a predefined threshold, a measurement is deemed as not found. The prediction is then shown as the position in the current time frame. Throughout the process, a confidence level is kept for each point. If a measurement is found, the confidence level is increased, otherwise it is decreased. Once the confidence level is low enough, the record of the point is deleted and the touch point is deemed as having disappeared.

Although for simplicity a scenario where only a single and two touch points are detected is described, the proposed systems and techniques, however, can be extended to handle more than two touch points by simply adding classes when training the classifier as well as increasing the states in the simplified Hidden Markov Model as described above. For example, in order to detect and track three points, three classes are defined in the classifier during training and three states are defined in the simplified Hidden Markov Model.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An apparatus detecting at least one touch point comprising:
a surface having a first dimension and second dimension;
a first plurality of sensors deployed along the first dimension and generating a first plurality of sensed signals caused by the at least one touch point, wherein the first plurality of sensors provide a first dataset indicating the first plurality of sensed signals as a first function of position on the first dimension;
a second plurality of sensors deployed along the second dimension and generating a second plurality of sensed signals caused by the at least one touch point, wherein the second plurality of sensors provide a second dataset indicating the second plurality of sensed signals as a second function of position on the second dimension, wherein the first plurality of sensors and the second plurality of sensors operate independently to each other; and
a trained-model based processing unit processing the first and second datasets to determine a position for each of the at least one touch point.

2. The apparatus of claim 1, wherein the processing unit comprises a touch point classifier that determines a number of the at least one touch point based on statistic features of the first and second dataset.

3. The apparatus of claim 2, wherein the statistic features are mean, standard deviation, and skewness.

4. The apparatus of claim 2, wherein the touch point classifier develops a model by using training data, wherein the model classifies the first and second datasets by the number of the at least one touch points.

5. The apparatus of claim 2, wherein the touch point classifier is a Gaussian density classifier.

6. The apparatus of claim 5, wherein the Gaussian density classifier develops the model by using K-fold cross validation.

7. The apparatus of claim 2, wherein the processing unit further comprises a confirmation module that statistically verifies the number of the at least one touch point determined by the touch point classifier.

8. The apparatus of claim 7, wherein the confirmation module determines a probability of occurrence for the number of the at least one touch point determined by the touch point classifier based on a history of verified determinations of the touch point classifier.

9. The apparatus of claim 7, wherein the confirmation module employs a Hidden Markov model.

10. The apparatus of claim 9, wherein the confirmation module employs a homogeneous Hidden Markov model.

11. The apparatus of claim 7, wherein the processing unit further comprises a tracker that predicts a next position of the least one touch point.

12. The apparatus of claim 11, wherein the tracker employs a Kalman filter.

13. The apparatus of claim 11, wherein the processing unit further comprises a data store that stores history data of positions of each of the at least one touch point at each time point, wherein the tracker predicts and assigns at least one trajectory to each of the at least one touch points, wherein the processing unit determines the position for each of the at least one touch point by utilizing the assigned trajectory to the touch point.

14. A method comprising:
detecting a first dataset indicating a first plurality of sensed signals as a first function of position on a first dimension of a touch surface;
detecting a second dataset indicating a second plurality of sensed signals as a second function of position on a second dimension of the touch surface; and
processing the first and second datasets to determine a position for each of at least one touch point on the surface by using a trained-model.

15. The method of claim 14, further comprising
collecting history data of positions of each of the at least one touch point at each time point;
predicting and assigning at least one trajectory to each of the at least one touch points; and
determining the position for each of the at least one touch point by utilizing the assigned trajectory to the touch point.
